(19) United States
(12) Patent Application Publication
(10) Pub. No.: US 2023/0239317 A1
(43) Pub. Date: Jul. 27, 2023

(54) Identifying and Mitigating Security Vulnerabilities in Multi-Layer Infrastructure Stacks

(71) Applicant: Dell Products L.P., Round Rock, TX (US)

(72) Inventors: Vaideeswaran Ganesan, Bangalore (IN); Pravin Janakiram, Bangalore (IN)

(21) Appl. No.: 17/586,099

(22) Filed: Jan. 27, 2022

(51) Int. Cl. H04L 9/40

(52) U.S. Cl. CPC H04L 63/1433; H04L 63/20

(57) ABSTRACT

Techniques are provided for identifying and mitigating security vulnerabilities in multi-layer infrastructure stacks. One method comprises obtaining vulnerability information associated with a security vulnerability for a component in a server device, wherein the server device is associated with a multi-layer infrastructure stack, and wherein the vulnerability information is obtained from a vulnerability catalog that identifies the security vulnerability for the component; exchanging at least portions of the vulnerability information among at least some layers of the multi-layer infrastructure stack; identifying a remedial action to mitigate the security vulnerability using an update catalog that identifies a remedial action for the component to mitigate a corresponding security vulnerability; and automatically initiating the remedial action. The security vulnerability can be associated with (i) a passthrough channel between two components that reside in non-adjacent layers of the multi-layer infrastructure stack; and/or (ii) an interface that exposes a network connection.

### FIELD

The field relates generally to information processing systems, and more particularly to techniques for securing such information processing systems.

### BACKGROUND

Infrastructure stacks, sometimes referred to as “full stacks,” are often deployed in computing environments. An infrastructure stack comprises multiple layers of infrastructure elements, such as hardware elements, software elements and clusters of hardware elements, and often employs one or more management consoles for managing the infrastructure elements. For example, the infrastructure elements in an infrastructure stack may comprise software-defined storage elements, hyperconverged infrastructure, and various types of clusters. The management consoles allow multiple instances of a given infrastructure stack to be deployed and managed. Such infrastructure stacks can be problematic, particularly with regard to securing one or more of the infrastructure elements across the multiple layers of an infrastructure stack.

### SUMMARY

In one embodiment, a method comprises obtaining vulnerability information associated with one or more security vulnerabilities for at least one component in a server device, wherein the server device is associated with a multi-layer infrastructure stack comprising a plurality of layers, and wherein the vulnerability information is obtained from one or more vulnerability catalogs that identify the one or more security vulnerabilities for one or more of the at least one component associated with the multi-layer infrastructure stack; exchanging at least portions of the vulnerability information among one or more subsets of the plurality of layers; identifying one or more remedial actions to mitigate at least one of the one or more security vulnerabilities using one or more update catalogs that identify at least one remedial action for one or more of the at least one component to mitigate a corresponding security vulnerability; and automatically initiating at least one of the one or more remedial actions.

In some embodiments, the vulnerability information for a given security vulnerability identifies, for a given layer of the multi-layer infrastructure stack, the one or more of the at least one component associated with the given security vulnerability and/or an object representation exchanged between boundaries to a next layer of the multi-layer infrastructure stack. The one or more update catalogs may identify one or more versions of a given at least one component that address one or more of the security vulnerabilities associated with the given at least one component.

The one or more security vulnerabilities can be associated with (i) a passthrough channel between two of the at least one component that reside in non-adjacent layers of the multi-layer infrastructure stack; and/or (ii) an interface that exposes a network connection that does not satisfy one or more security policies.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for identifying and mitigating security vulnerabilities in multi-layer infrastructure stacks in accordance with an illustrative embodiment;

FIG. 2 illustrates an exemplary infrastructure stack related to the information processing system of FIG. 1 in accordance with an illustrative embodiment;

FIG. 3 illustrates an exemplary host computing device of FIG. 1 in further detail in accordance with an illustrative embodiment;

FIG. 4 illustrates an exemplary management console server of FIG. 1 in further detail in accordance with an illustrative embodiment;

FIG. 5 illustrates an exemplary implementation of the infrastructure stack processing server of FIG. 1 as an infrastructure stack vulnerability mitigation server, in accordance with one embodiment;

FIG. 6 illustrates an exemplary passthrough channel between a virtual machine and a hardware device, such as a disk, in accordance with an illustrative embodiment;

FIG. 7 illustrates an exemplary channel between an operating system and a management controller in a host computing device of FIG. 1 in accordance with an illustrative embodiment;

FIG. 8 illustrates an exemplary process for identifying and mitigating security vulnerabilities in multi-layer infrastructure stacks in accordance with an illustrative embodiment;

FIG. 9 illustrates portions of the host computing device of FIG. 3 in further detail in accordance with an illustrative embodiment;

FIG. 10A through 10C illustrate exemplary processes associated with various services of the host computing device of FIG. 9 in accordance with an illustrative embodiment;

FIG. 11 is a sample table of an exemplary passthrough channel data structure that records vulnerability information that is exchanged among the layers of an infrastructure stack, according to an embodiment of the disclosure;

FIG. 12 is a flow chart illustrating an exemplary implementation of a security vulnerability mitigation process that identifies and mitigates one or more security vulnerabilities in a multi-layer infrastructure stack in accordance with an illustrative embodiment;

FIG. 13 illustrates an exemplary processing platform that may be used to implement at least a portion of one or more embodiments of the disclosure comprising a cloud infrastructure; and

FIG. 14 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for identifying and mitigating security vulnerabilities in multi-layer infrastructure stacks.

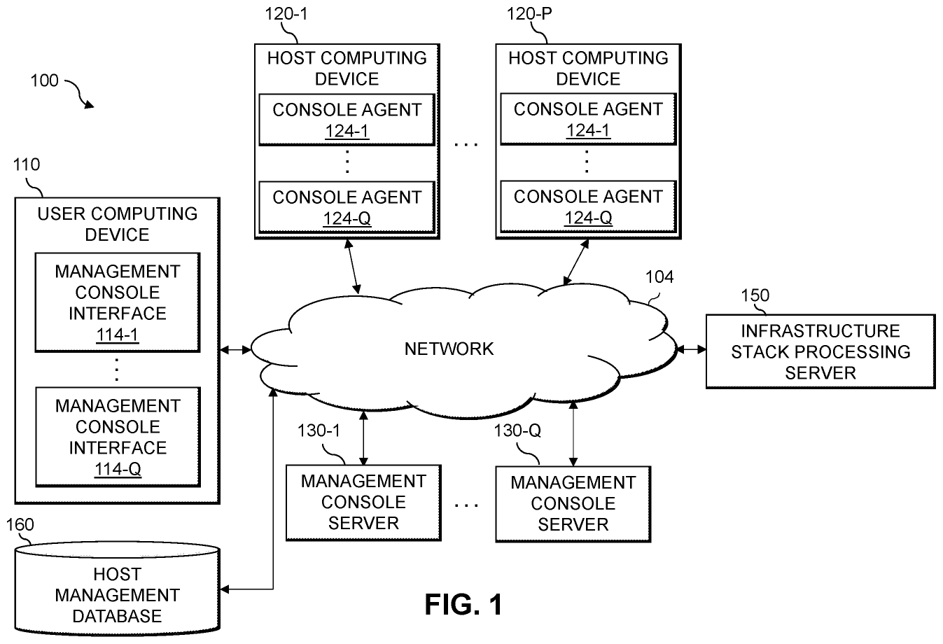

FIG. 1 shows a computer network (also referred to herein as an information processing system) 100 configured in accordance with an illustrative embodiment. The computer network 100 comprises one or more user computing devices 110, a plurality of host computing devices 120-1 through 120-P, collectively referred to herein as host computing devices 120, a plurality of management console servers 130-1 through 130-Q, collectively referred to herein as management console servers 130, and one or more infrastructure stack processing servers 150. The user computing device 110, host computing devices 120, management console servers 130 and infrastructure stack processing server 150 are coupled to a network 104 in the example of FIG. 1, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment.

The one or more user computing devices 110 may each be associated with, for example, an IT administrator, and may comprise, for example, devices such as mobile telephones, laptop computers, tablet computers, desktop computers or other types of computing devices (e.g., virtual reality (VR) devices or augmented reality (AR) devices). Some of these processing devices are also generally referred to herein as “computers.” The user computing devices 110 may comprise a network client that includes networking capabilities such as ethernet, Wi-Fi, etc.

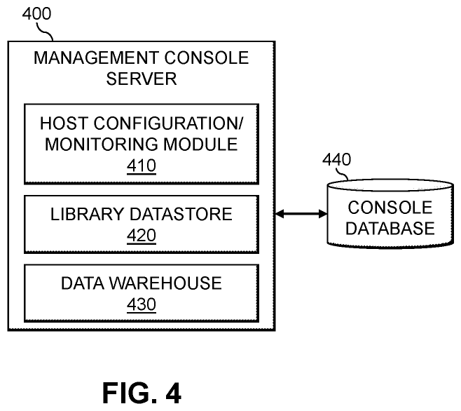

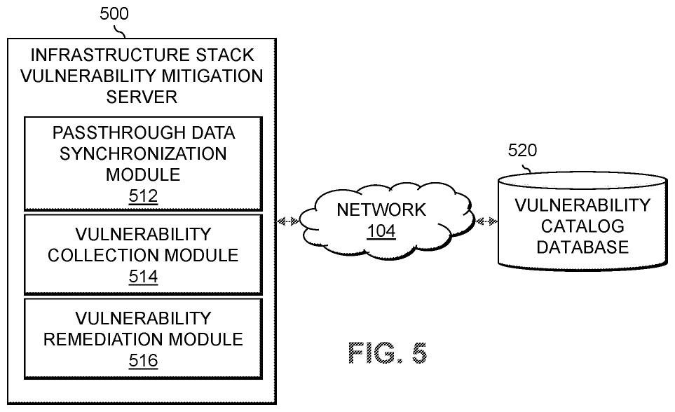

In the example of FIG. 1, the exemplary user computing device 110 comprises one or more management console user interfaces (UIs) 114-1 through 114-Q to interact with one or more of the management console servers 130, as discussed further below. It is noted that, in some embodiments, a given user computing device 110 may not require a management console UI 114 for each of the available management console servers 130. A representative management console server 130 is discussed further below in conjunction with FIG. 4. The one or more infrastructure stack processing servers 150 are discussed further below in conjunction with FIG. 5.

It is to be appreciated that the term “user” as used herein is intended to be broadly construed so as to encompass, for example, human, hardware, software or firmware entities, as well as various combinations of such entities. Compute and/or storage services may be provided for users under a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The host computing devices 120 may comprise, for example, server devices or other types of computers of an enterprise computer system, cloud-based computer system or other arrangement of multiple compute nodes associated with respective users. Such devices are examples of what are more generally referred to herein as “processing devices.” Some of these processing devices are also generally referred to herein as “computers.” The host computing devices 120 may comprise a network client that includes networking capabilities such as ethernet, Wi-Fi, etc.

For example, the host computing devices 120 in some embodiments illustratively provide compute services such as execution of one or more applications on behalf of each of one or more users associated with respective ones of the user computing devices 110. Such applications illustratively generate input-output (TO) operations that are processed by a storage system. The term “input-output” as used herein refers to at least one of input and output. For example, IO operations may comprise write requests and/or read requests directed to logical addresses of a particular logical storage volume of the storage system. These and other types of IO operations are also generally referred to herein as IO requests.

The host computing devices 120 in some embodiments may comprise respective processing devices associated with a particular company, organization or other enterprise or group of users. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

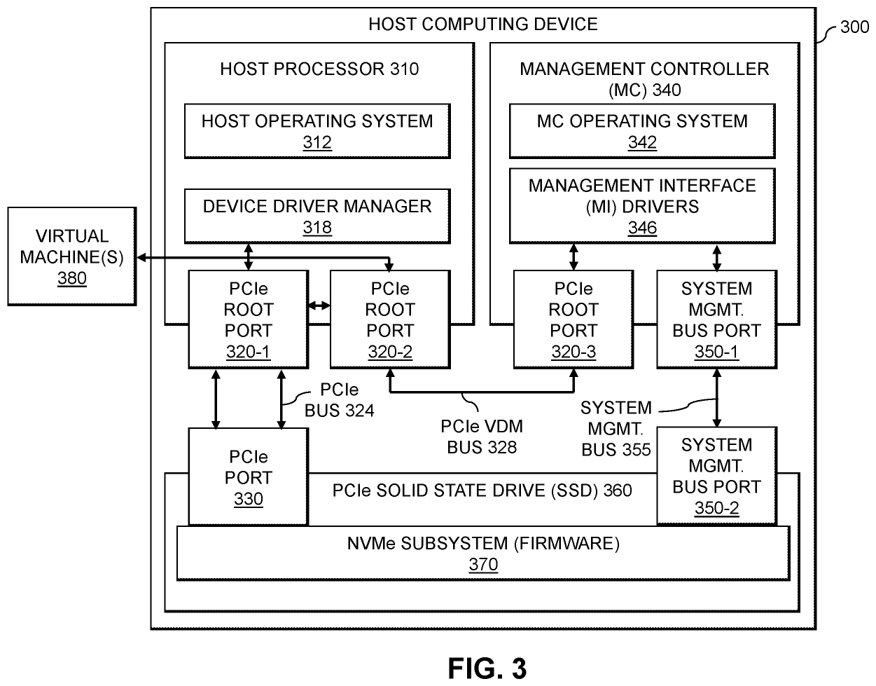

In the example of FIG. 1, the exemplary host computing devices 120 comprise one or more console agents 124-1 through 124-Q to interact with one or more of the management console servers 130. An exemplary implementation of a representative host computing device 120 is discussed further below in conjunction with FIG. 3. It is noted that, in some embodiments, a given host computing device 120 may not require a console agent 124 for each of the available management console servers 130.

One or more of the user computing devices 110, host computing devices 120, management console servers 130, and/or infrastructure stack processing servers 150 illustratively comprise processing devices of one or more processing platforms. For example, a representative infrastructure stack processing server 150 can comprise one or more processing devices each having a processor, a memory and a network interface, possibly implementing virtual machines and/or containers, although numerous other configurations are possible. The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements. The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more of the user computing devices 110, host computing devices 120, management console servers 130, and/or infrastructure stack processing servers 150 can additionally or alternatively be part of edge infrastructure and/or cloud infrastructure such as an Amazon Web Services (AWS) system. Other examples of cloud-based systems that can be used to provide at least portions of the user computing devices 110, host computing devices 120, management console servers 130, and/or infrastructure stack processing servers 150 include Dell Cloud, Google Cloud Platform (GCP) and Microsoft Azure.

Additionally, one or more of the user computing devices 110, the host computing devices 120, the management console servers 130 and/or the infrastructure stack processing server 150 can have one or more associated host management databases 160. Although the management information is stored in the example of FIG. 1 in a single host management database 160, in other embodiments, an additional or alternative instance of the host management database 160, or portions thereof, may be incorporated into portions of the system 100.

The one or more host management databases 160 may be configured to store, for example, update baselines, vulnerability catalogs, update catalogs, attribute registries and/or workflow databases, portions thereof and/or multiple instances of any of the foregoing, as discussed further below. The host management database 160 may be accessed, for example, in connection with managing one or more of the host computing devices 120.

The one or more host management databases 160 can be implemented using one or more storage systems associated with the respective devices 110, 120, 130 and/or 150. Such storage systems can comprise any of a variety of different types of storage including such as network-attached storage (NAS), storage area networks (SANs), direct-attached storage (DAS) and distributed DAS, as well as combinations of these and other storage types, including software-defined storage.

The storage devices in such storage systems illustratively comprise solid state drives (SSDs). Such SSDs are implemented using NVM devices such as flash memory. Other types of NVM devices that can be used to implement at least a portion of the storage devices include non-volatile RAM (NVRAM), phase-change RAM (PC-RAM), magnetic RAM (MRAM), resistive RAM, spin torque transfer magneto-resistive RAM (STT-MRAM), and Intel Optane™ devices based on 3D XPoint™ memory. These and various combinations of multiple different types of NVM devices may also be used. For example, hard disk drives (HDDs) can be used in combination with or in place of SSDs or other types of NVM devices in the storage system.

The term “storage system” as used herein is therefore intended to be broadly construed, and should not be viewed as being limited to particular storage system types, such as, for example, CAS (content-addressable storage) systems, distributed storage systems, or storage systems based on flash memory or other types of NVM storage devices. A given storage system as the term is broadly used herein can comprise, for example, any type of system comprising multiple storage devices, such as NAS, SANs, DAS and distributed DAS, as well as combinations of these and other storage types, including software-defined storage.

One or more of the user computing devices 110, host computing devices 120, management console servers 130 and/or infrastructure stack processing server 150 may be implemented on a common processing platform, or on separate processing platforms. The host computing devices 120 are illustratively configured to write data to and read data to/from a storage system in accordance with applications executing on those host devices for system users. One or more of the user computing devices 110, host computing devices 120, management console servers 130 and/or infrastructure stack processing server 150 may be implemented, for example, on the cloud or on the premises of an enterprise or another entity.

The host computing devices 120 are configured to interact over the network 104, for example, with one or more of the management console servers 130 and/or storage devices. Such interaction illustratively includes generating IO operations, such as write and read requests, and sending such requests over the network 104.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the host computing devices 120 and a storage system to reside in different data centers. Numerous other distributed implementations of the host devices and storage systems are possible.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the user computing devices 110, the host computing devices 120, the management console servers 130 and/or the infrastructure stack processing server 150 can be one or more input-output devices (not shown), which illustratively comprise keyboards, displays or other types of input-output devices in any combination. Such input-output devices can be used, for example, to support one or more user interfaces to such devices 110, 120, 130 and/or 150, as well as to support communication between such devices 110, 120, 130 and/or 150 and other related systems and devices not explicitly shown.

It is to be appreciated that this particular arrangement of elements in the user computing devices 110, the host computing devices 120 and/or the management console servers 130 of the FIG. 1 embodiment is presented by way of example only, and alternative arrangements can be used in other embodiments. For example, the functionality associated with at least some of the management console UIs 114-1 through 114-Q and/or console agents 124-1 through 124-Q in other embodiments can be implemented as a single element or device; separated across a larger number of elements; and/or implemented using multiple distinct processors. At least portions of such elements may be implemented at least in part in the form of software that is stored in memory and executed by a processor.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including SSDs, and should therefore not be viewed as limited in any way to spinning magnetic media.

It is to be understood that the particular set of elements shown in FIG. 1 for security vulnerability mitigation is presented by way of illustrative example only, and in other embodiments additional or alternative elements may be used. Thus, another embodiment includes additional or alternative systems, devices and other network entities, as well as different arrangements of modules and other components.

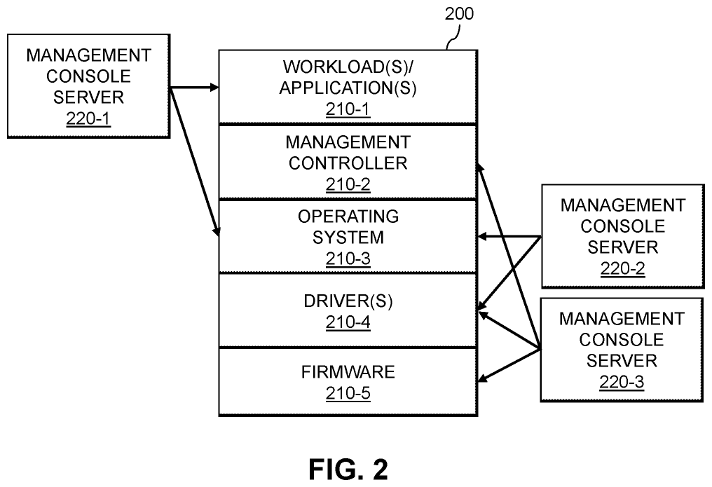

FIG. 2 illustrates an exemplary infrastructure stack 200 related to the information processing system of FIG. 1 in accordance with an illustrative embodiment. In the example of FIG. 2, the infrastructure stack 200 comprises a plurality of stack layers 210-1 through 210-5, such as a workloads or applications layer 210-1; a management controller layer 210-2, an operating system layer 210-3; a driver layer 210-4; and a firmware layer 210-5. The exemplary infrastructure stack 200 is managed by a plurality of management console servers 220-1 through 220-3. Each management console server 220 manages one or more layers of the infrastructure stack 200. In addition, in some embodiments, multiple management console servers 220 may manage at least some of the infrastructure elements in the same layer 210. In the example of FIG. 2, the management console server 220-1 and the management console server 220-2 both manage at least some of the infrastructure elements in the operating system layer 210-3 (potentially causing one or more inconsistencies).

In at least some embodiments, each layer 210 of the infrastructure stack 200 may have different attribute registries than other layers 210, and each layer 210 may have a different attribute registry for each technology variation (for example, a corresponding attribute registry may be provided by the provider of a given technology on each layer 210).

For example, an OpenManage Enterprise (OME) management console may manage, e.g., firmware, drivers and the management controller in layers 210-5, 210-4 and 210-2, respectively. In addition, an SCVMM (System Center Virtual Machine Manager) management console may manage, e.g., drivers and the operating system in layers 210-4 and 210-3, respectively. Further, an MECM (Microsoft Endpoint Configuration Manager) console may manage, e.g., drivers and the operating system in layers 210-4 and 210-3, respectively.

FIG. 3 illustrates an exemplary host computing device 300 in accordance with an illustrative embodiment. In the example of FIG. 3, the exemplary host computing device 300 comprises a host processor 310, a management controller (MC) 340 and a PCIe (Peripheral Component Interconnect Express) SSD 360. The exemplary host processor 310 comprises a host operating system 312 and a device driver manager 318 that comprises and manages one or more device drivers, such as an NVMe device driver (not specifically shown in FIG. 2). Such drivers may be configured, secured and/or updated in accordance with some embodiments of the disclosure, as discussed further below.

In addition, the host processor 310 comprises two PCIe root ports 320-1 and 320-2 for communicating with a PCIe port 330 of the PCIe SSD 360 and a PCIe root port 320-3 of the management controller 340, respectively. The PCIe root port 320-1 communicates with the PCIe port 330 of the PCIe SSD 360 using a PCIe bus 324. The PCIe root port 320-2 communicates with the PCIe root port 320-3 of the management controller 340 using a PCIe VDM (Vendor Defined Message) bus 328 that channelizes the information to the management controller 340.

In one or more embodiments, the exemplary management controller 340 further comprises an MC operating system 342 and one or more management interface (MI) drivers 346, such as an NVMe-MI driver (not specifically shown in FIG. 3). The management interface drivers 346 each comprise a command set and architecture for managing respective firmware, such as NVMe firmware, to discover, monitor, configure, and update firmware in multiple operating environments.

The exemplary management controller 340 also comprises a system management bus port 350-1 that communicates with a system management bus port 350-2 of the PCIe SSD 360 using a system management bus 355 based on a serial communication protocol. The management controller 340 may be implemented, for example, as a baseboard management controller (BMC), such as the Integrated Dell Remote Access Controller (iDRAC), commercially available from Dell Technologies, or another out of band (OOB) controller.

In some embodiments, the exemplary host computing device 300 hosts one or more virtual machines 380 that communicate with at least portions of the exemplary host computing device 300 using the PCIe root port 320-2. For example, a given virtual machine 380 may directly request the management controller 340 (such as a BMC or an iDRAC) to update firmware (potentially bypassing the host operating system 312 and/or the drivers using a passthrough channel).

The exemplary PCIe SSD 360 is one example of a component of the exemplary host computing device 300 comprising firmware. As shown in the example of FIG. 3, the PCIe SSD 360 further comprises an NVMe subsystem 370 as an example of firmware that may be configured, secured and/or updated in accordance with some embodiments of the disclosure, as discussed further below.

FIG. 4 illustrates an exemplary management console server 400 in further detail in accordance with an illustrative embodiment. In the example of FIG. 4, the management console server 400 comprises a host configuration/monitoring module 410, a library datastore 420, and a data warehouse 430. A given management console server 400 may span (e.g., control) multiple clusters of the host computing devices 120 of FIG. 1.

The host configuration/monitoring module 410, in one or more embodiments, is configured to perform one or more functions for configuring, updating and/or monitoring one or more of the host computing devices 120 or other devices in the system 100 of FIG. 1. One or more of the management console servers 400 may be implemented in some embodiments, using an OpenManage Enterprise (OME) console, an SCVMM (System Center Virtual Machine Manager) console and/or an MECM (Microsoft Endpoint Configuration Manager) console.

In at least some embodiments, the management console server 400 can have one or more associated console databases 440 configured to store console data, such as information related to devices, update baselines, monitoring data (e.g., alerts and/or health status), and configuration data (e.g., configuration data related to clusters). Although the console information is stored in the example of FIG. 4 in a single console database 440, in other embodiments, an additional or alternative instance of the console database 440, or portions thereof, may be incorporated into portions of the system 100 of FIG. 1.

The library datastore 420 is configured in some embodiments to store, for example, operating system images, applications, patches and driver versions.

The data warehouse 430 is configured in some embodiments to store, for example, data from the console database 440 that has been pushed to the data warehouse 430, for example, for reporting purposes.

Individual infrastructure elements in an infrastructure stack, such as BMCs (Baseboard Management Controllers), hypervisors, and applications, and SIEM (security information and event management) solutions typically have their own technologies to address vulnerabilities at each layer of an infrastructure stack.

One or more aspects of the disclosure recognize that multi-layer security vulnerabilities are being exposed in infrastructure stacks due to passthrough devices (e.g., that allow a virtual machine to communicate directly with a physical device in the hardware layer, bypassing the hypervisor using a passthrough channel) as well as “backdoors” to other vulnerabilities (e.g., that allow Internet connections to an iDRAC (Integrated Dell Remote Access Controller) or another BMC). Further, many customers do not often upgrade their firmware and/or drivers in the infrastructure domain. Thus, workloads and infrastructure are both being exposed to security threats. A disjointed view of firmware, software and workload may lead to security vulnerabilities that may not be apparent to an IT or security administrator.

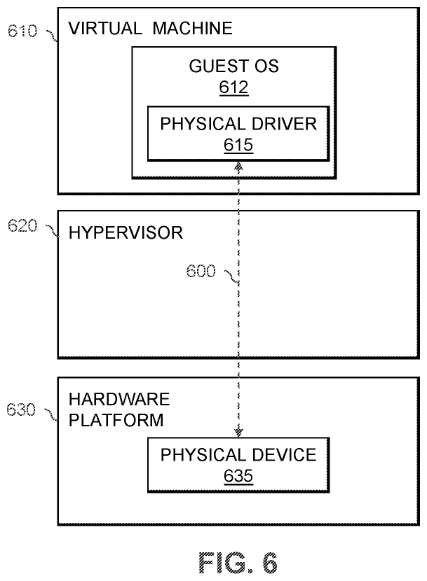

Such passthrough technologies may connect several seemingly independent domains, creating new threat vectors. For example, customers increasingly wish to expose hardware resources (e.g., (PCIe (Peripheral Component Interconnect Express) devices, disks, NVMe (NVM Express) devices, and GPUs (graphics processing units)) to virtual machines, potentially exposing workloads to firmware vulnerability risks; and potentially exposing the hardware resources to attacks through such virtual machines, as discussed further below in conjunction with FIG. 6.

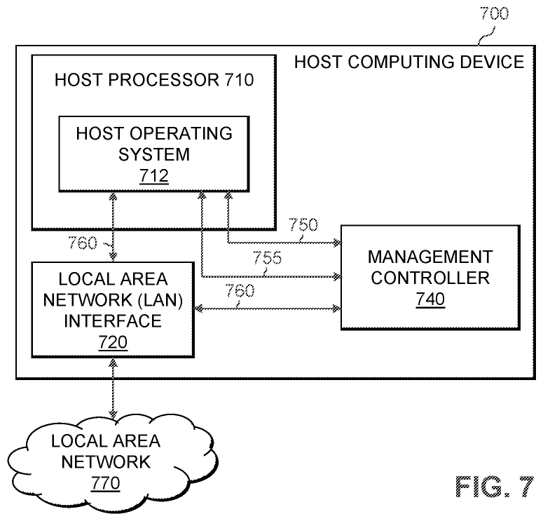

In at least some embodiments, a “backdoor” comprises a potential security risk resulting from an ability to gain access (often undocumented) to one or more infrastructure elements in an infrastructure stack. For example, soft boundaries between out-of-band devices (e.g., iDRACs and/or BMCs) and a host operating system (for example, using bridge software, sometimes referred to as an operating system-to-BMC channel) adds new threat vectors, for example, by exposing the out-of-band device to attacks through the host operating system (which is often connected to the Internet or another network), as discussed further below in conjunction with FIG. 7.

A mechanism is needed to enable security administrators to have an insight and awareness of these security vulnerabilities and how such vulnerabilities permeate throughout the system. Currently, security assessments are limited to assets within a particular domain (such as virtual machine, BMC or Host domains). A need exists for techniques for identifying the passthrough channels and other vulnerabilities in a multi-layer infrastructure stack, documenting how such vulnerabilities permeate through such multiple layers of an infrastructure stack and for initiating one or more remedial measures.

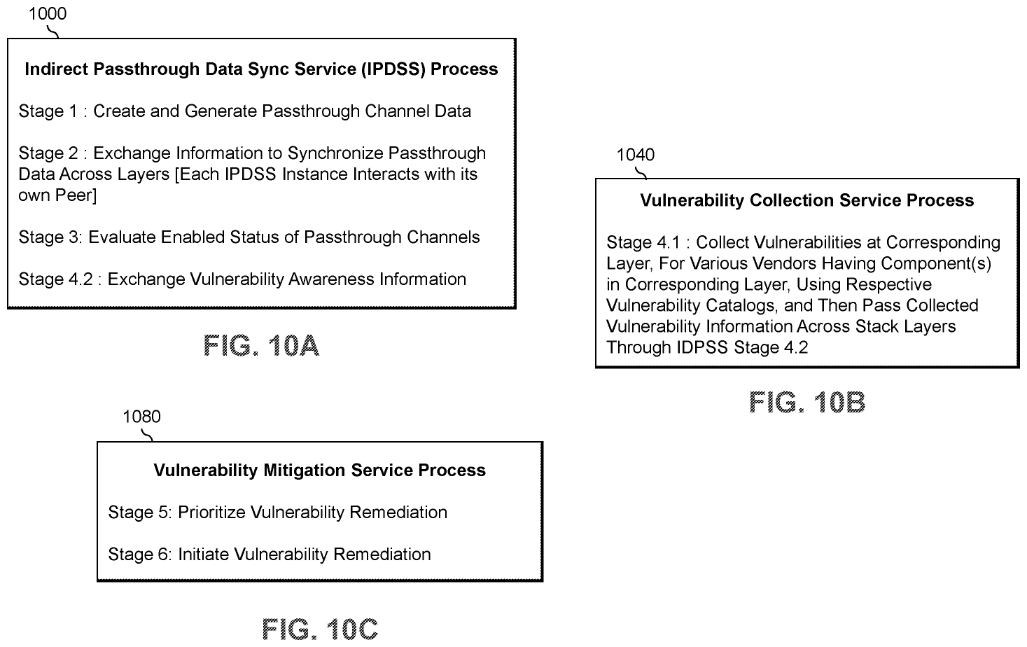

FIG. 5 illustrates an exemplary implementation of the infrastructure stack processing server 150 of FIG. 1 as an infrastructure stack vulnerability mitigation server 500, in accordance with one embodiment. In the example of FIG. 5, the infrastructure stack vulnerability mitigation server 500 comprises a passthrough data synchronization module 512, a vulnerability collection module 514, a vulnerability remediation module 516, and a vulnerability catalog database 520, each discussed further below in conjunction with FIGS. 10A, 10B, and 10C, respectively.

The infrastructure stack vulnerability mitigation server 500 may interact over the network 104, for example, to access a vulnerability catalog database 520 configured to store, for example, one or more vulnerability catalogs, as discussed further below. Although the vulnerability catalog information is stored in the example of FIG. 5 in a single vulnerability catalog database 520, in other embodiments, an additional or alternative instance of the vulnerability catalog database 520, or portions thereof, may be incorporated into portions of the system 100.

It is to be appreciated that this particular arrangement of modules 512, 514, 516 illustrated in the infrastructure stack vulnerability mitigation server 500 of FIG. 5 is presented by way of example only, and alternative arrangements can be used in other embodiments. For example, the functionality associated with elements 512, 514, 516 in other embodiments can be implemented as a single element or device, or separated across a larger number of elements. As another example, multiple distinct processors can be used to implement different ones of elements 512, 514, 516, or portions thereof.

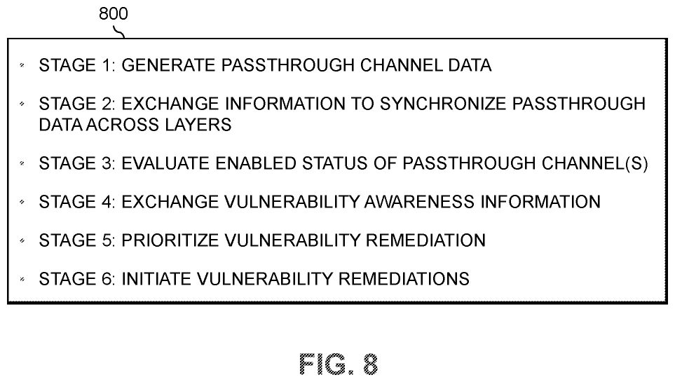

At least portions of elements 512, 514, 516 may be implemented at least in part in the form of software that is stored in memory and executed by a processor. An exemplary process utilizing elements 512, 514, 516 of the infrastructure stack vulnerability mitigation server 500 of FIG. 5 will be described in more detail with reference to, for example, FIGS. 8, 9 and 10A through 10C.

FIG. 6 illustrates an exemplary passthrough channel 600 between a virtual machine 610 and a physical hardware device 635, such as a disk, on a hardware platform 630, in accordance with an illustrative embodiment. In the example of FIG. 6, a physical driver 615 associated with, for example, a guest operating system 612 of the virtual machine 610 communicates using a passthrough channel 600 with a physical device 635, such as a disk, in the hardware layer of an infrastructure stack. The passthrough channel 600 may employ, for example, a SR-IOV (single root I/O virtualization (SR-IOV) interface. The passthrough channel 600 connects the physical driver 615 and the physical device 635 through a hypervisor 620.

The hypervisor 620 redirects calls from the guest operating system 612, translates calls to physical devices 635, and provides hardware protection. The disclosed passthrough mechanism allows the virtual machine 610 to access the physical device 635, for example, through a shim in the hypervisor 620. In this manner, the virtual machine 610 gains direct access to the physical hardware of the physical device 635, enabling the virtual machine 610 to leverage the physical hardware directly. Among other benefits, the passthrough channel 600 avoids overhead associated with the hypervisor 620 (for example, due to call translations and double caching). Thus, the passthrough channel 600 improves the latency and speed offered by the hardware. One or more aspects of the disclosure, however, recognize that such direct exposure to the hardware also exposes security vulnerabilities (e.g., attacks from inside the virtual machine, through the hypervisor 620 or the management network (e.g., an iDRAC). Workloads using these physical devices directly (through the passthrough channel) may be exposed to vulnerability/security risks, for example, posed by the firmware running on these devices.

As discussed further below, in one or more embodiments, mappings are collected between such physical devices 635 and the workloads associated with the guest operating system 612. Areas of potential exposure and security risks are identified by performing a multi-layer security assessment, and one or more remedial recommendations can be provided, for example, using one or more application programming interfaces (APIs).

FIG. 7 illustrates a host computing device 700 comprising a host processor 710 and a management controller 740 in accordance with an illustrative embodiment. The host computing device is also connected to a local area network (LAN) 770 using a LAN interface 720 (e.g., a LAN on motherboard (LOM) device). In the example of FIG. 7, the LAN interface 720 communicates with the host operating system 712 in some embodiments using a PCIe (Peripheral Component Interconnect Express) standard and provides a network connectivity status indicator (NC-SI) to the iDRAC, over a LAN-to-MC channel 760. One or more exemplary operating system-to-management controller channels 750, 755 connect the management controller 740 (e.g., an iDRAC) to the host operating system 712.

One or more aspects of the disclosure recognize that that an iDRAC or another privileged management controller should not be exposed to the Internet to prevent attacks. The operating system-to-management controller channels 750, 755, however, expose the management controller 740 to the Internet when the host operating system 712 is exposed to the Internet. The operating system-to-management controller channels 750, 755 may expose the management controller 740 to attacks through the Internet thus allowing access to the management controller 740 through the operating system 712. A bad actor may employ one or more of the operating system-to-management controller channels 750, 755 to capture the host computing device 700, and/or inject invalid (e.g., rogue) and/or corrupted firmware on the management controller 740 that could, for example, erase a disk. It is noted that such indirection associated with the operating system-to-management controller channels 750, 755 makes it difficult to trace through the path between the rogue actor and the management controller 740.

In some embodiments, one or more of the operating system-to-management controller channels 750, 755 are built on top of KCS (Keyboard Controller Style) interfaces that provide unauthenticated local access to the iDRAC. However, this channel should be accessible only to users with local administrator or root access.

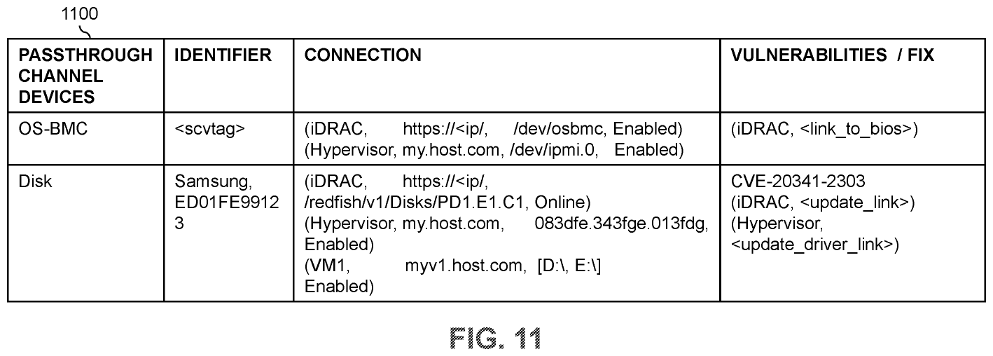

FIG. 8 illustrates an exemplary process 800 for identifying and mitigating security vulnerabilities in multi-layer infrastructure stacks in accordance with an illustrative embodiment. In the example of FIG. 8, the first stage of the process 800 comprises generating passthrough channel data. Passthrough channel data structures, discussed further below in conjunction with FIG. 11, are employed in some embodiments to carry the details of any passthrough channels and/or interfaces that may result in indirect impacts to vulnerability (e.g., for channels that bypass one or more layers of the multi-layer infrastructure stack, such as the operating system-to-MC channel, and/or other backdoor vulnerabilities). In some embodiments, the vulnerability impact can be assessed by one or more infrastructure stack elements or by an external entity, such as an OME console.

As discussed further below in conjunction with FIG. 11, the exemplary passthrough data structures may be populated by the object owner (e.g., a BMC or hypervisor) and identify, at each layer of the infrastructure stack, the passthrough device and may provide an object representation exchanged between boundaries to the next layer.

In the second stage of the process 800, the passthrough channel data is synchronized among the multiple layers of the infrastructure stack using an information exchange between entities. The information exchange continues in at least some embodiments until the entities (e.g., virtual machines, hypervisors and the BMC) across the multiple layers acquire the knowledge about the vulnerabilities in the system (e.g., for direct and indirect connections). When the components within the multiple layers of the infrastructure stack are reporting similar information, then it can be assumed that a stable equilibrium is reached. The information exchange can be triggered, for example, during system startup or on an operation that creates such a passthrough channel. For example, the hypervisor may know that a physical device is attached to a passthrough channel and the hypervisor may share information about the physical device with the virtual machine through a hypervisor integration module. The hypervisor may create an entry in the passthrough channel data, as discussed further below in conjunction with FIG. 11, and then push this information to other layers of the stack (e.g., up to one or more virtual machines and/or down to the BMC).

Each layer resolves the information using universal identifiers of the impacted components, as discussed further below in conjunction with FIG. 11. In the case of a BMC, the universal identifier is mapped to a physical device endpoint structure. In case of a virtual machine, the universal identifier is mapped to a physical device, (e.g., a drive that is newly exposed into the system). When the virtual machine does not have this knowledge, the hypervisor can use the hypervisor/virtual machine channel to collect and reconcile the information.

In at least some embodiments, the information exchange continues until all of the components of the infrastructure stack have the same elements. It is noted that this exchange can also extend into the workload layers (e.g., where workloads like SAP (Systems, Applications & Products) and Oracle may be creating their databases/tablespaces on top of raw disks). Collecting the information from these layers also helps to give every element of the infrastructure stack the knowledge of how the vulnerability may impact the workloads. A protocol can be established where the exchange starts on an operation, and then continues until equilibrium is reached, as would be apparent to a person of ordinary skill in the art.

In the third stage of the process 800, the enabled status of one or more passthrough channels is evaluated. In at least some embodiments, the channel enabled status of a given passthrough channel indicates whether the given passthrough channel is active or not. For example, even though an operating system-to-MC channel is activated in the operating system, the passthrough channel may be disabled by the iDRAC. The channel status at each endpoint is also exchanged between neighboring entities in the infrastructure stack, for example, using the information exchange techniques described above. In some embodiments, the propagation of the passthrough channel information may be facilitated by only propagating the channel enabled status within the infrastructure stack when there is a change in the channel status. If a particular passthrough channel is disabled the potential vulnerability associated with the passthrough channel is not exposed.

In the fourth stage of the process 800, vulnerability awareness information is exchanged. The vulnerability awareness information exchange is triggered in some embodiments by an operation, such as a Vulnerability/Update Compliance operation. When such an operation is performed, the current firmware/driver/software versions of the components present in the passthrough channel are evaluated. Vulnerabilities for those components are assessed and updated into the passthrough channel data structure, as discussed further below in conjunction with FIG. 11. Similarly, the latest firmware/driver/software versions that mitigate (e.g., fix) the indicated vulnerabilities may also be exchanged, along with the location where the mitigation actions/operations should be performed. For example, a GPU driver vulnerability can be fixed at the operating system layer, while a disk firmware vulnerability can be fixed at the iDRAC Layer. The vulnerability awareness information is now available within the infrastructure stack (thus providing full vulnerability visibility within the stack).

The vulnerability awareness information can be obtained from existing vulnerability catalogs (e.g., using a REST API.) and/or other data sources (e.g., that identify particular vulnerabilities for particular infrastructure elements). A Common Vulnerability Scoring System (CVSS) may be used to evaluate the threat level of a vulnerability and/or to prioritize the security of vulnerabilities. In at least some embodiments, each layer of the infrastructure stack can evaluate the vulnerability awareness information to evaluate vulnerabilities for the installed versions to reveal any vulnerability issues (e.g., with a driver).

In at least some embodiments, one or more vulnerability catalogs (e.g., glossaries that classify vulnerabilities) are employed that comprise details about known vulnerabilities per infrastructure component. In addition, update catalogs comprise information for each component of the fixes and/or other mitigation actions related to such vulnerabilities (e.g., identifying which version of an infrastructure component (e.g., a driver) fixes an identified security vulnerability). Thus, given an infrastructure component, it is possible to extract one or more potential vulnerabilities, as well as the updates that will fix or mitigate such vulnerabilities. For example, a vulnerability catalog may identify a vulnerability associated with firmware for a solid-state drive (SSD) indicating that attackers with privileged access to the SSD firmware have full access to encrypted data.

In one or more embodiments, at least some of the functionality of the security vulnerability identification and mitigation process of FIG. 8 may be implemented in a management console that services multiple deployments of a given infrastructure stack (or portions thereof). For example, such a management console may comprise one or more of an OME console, an SCVMM (System Center Virtual Machine Manager) console, or an MECM (Microsoft Endpoint Configuration Manager) console.

In the fifth stage of the process 800, one or more proposed vulnerability remediations may be prioritized. One or more aspects of the disclosure recognize that an IT Service Management (ITSM) tool, such as ServiceNow, can evaluate the vulnerability awareness information to optionally prioritize multiple vulnerability remediations by assessing the impact of such vulnerabilities to a given business. In ServiceNow, devices and workloads are rolled into services which are then rolled into business domains. Thus, ServiceNow can assess and quantify the business impact of one or more passthrough vulnerabilities and/or backdoor vulnerabilities. With the vulnerability data associated with infrastructure elements and a time duration (e.g., an estimated time duration) to mitigate each of the infrastructure elements, ServiceNow can (i) assess the business impact of the passthrough and/or backdoor vulnerabilities; and (ii) quantify a more accurate fix duration (or other measure of cost) required to address such vulnerabilities. Considering that there is insight into the location of the vulnerability and the elements that are going to be mitigated, the fix assessment will be more accurate and comprehensive. For example, if a marketing infrastructure stack and a financial infrastructure stack (e.g., subject to regulations specifying data retention and privacy preservation) are impacted by one or more passthrough and/or backdoor vulnerabilities, the mitigation of such passthrough and/or backdoor vulnerabilities can be prioritized to mitigate, for example, the finance infrastructure stack and then the marketing infrastructure stack, from a business impact perspective.

In the sixth stage of the process 800, one or more vulnerability remediations and/or mitigations are initiated. Considering that there is a perspective of any such identified vulnerabilities across multiple layers of the infrastructure stack, as well as the impact and knowledge of locations for mitigating such vulnerabilities, the appropriate mitigation actions can be automatically implemented and/or initiated to address the vulnerabilities in one or more layers of the infrastructure stack (including an application layer).

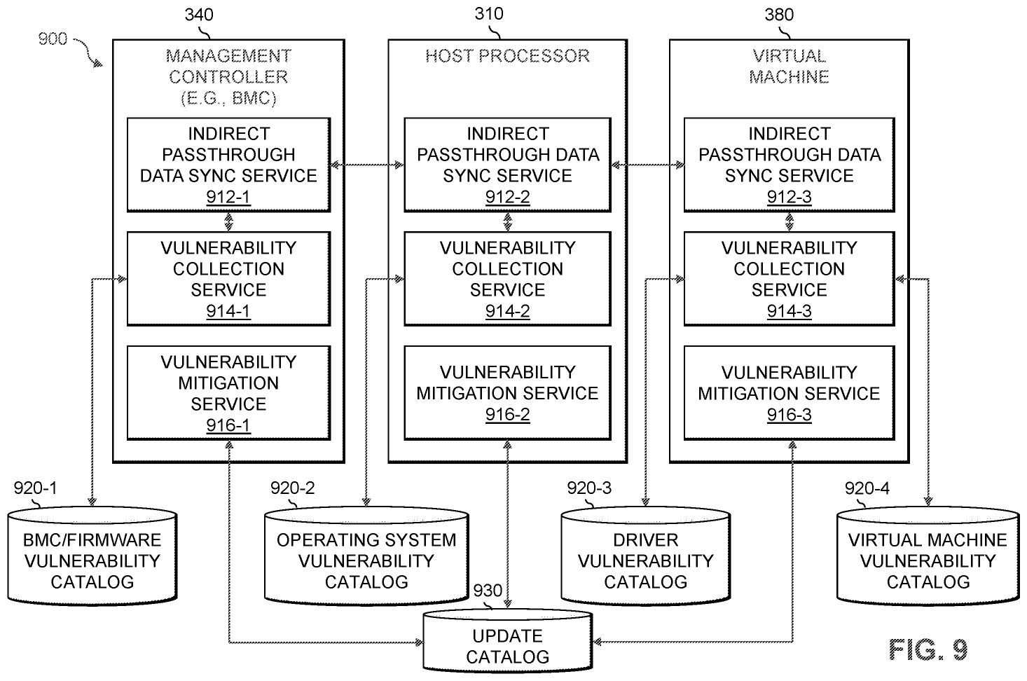

FIG. 9 illustrates portions 900 of an exemplary host computing device in accordance with an illustrative embodiment. In the example of FIG. 9, a management controller 340, a host processor 310 and a virtual machine 380 each comprise a respective instance of an indirect passthrough data synchronization service 912-1 through 912-3, a vulnerability collection service 914-1 through 914-3, and a vulnerability mitigation service 916-1 through 916-3. The functionality of the indirect passthrough data synchronization service 912, the vulnerability collection service 914, and the vulnerability mitigation service 916 are discussed further below in conjunction with FIGS. 10A, 10B and 10C, respectively.

The indirect passthrough data synchronization services 912-1 through 912-3 may be employed, for example, to exchange the passthrough channel data among the multiple layers of the infrastructure stack in the second stage of the process 800 of FIG. 8.

As shown in FIG. 9, each instance of the vulnerability collection service 914 accesses vulnerability information in one or more vulnerability catalogs 920. The vulnerability catalogs 920 comprise details about known vulnerabilities for each infrastructure component in an infrastructure stack. For example, the vulnerability collection service 914-1 associated with the management controller 340 accesses a BMC/firmware vulnerability catalog 920-1 (for example, a firmware vulnerability catalog 920-1 may identify a vulnerability associated with firmware for a solid-state drive (SSD) indicating that attackers with privileged access to the SSD firmware have full access to encrypted data); the vulnerability collection service 914-2 associated with the host processor 310 accesses an operating system vulnerability catalog 920-2; and the vulnerability collection service 914-3 associated with the virtual machine 380 accesses a driver vulnerability catalog 920-3 and a virtual machine vulnerability catalog 920-4.

Further, each instance 916-1 through 916-3 of the vulnerability mitigation service 916 accesses vulnerability remediation information in one or more update catalogs 930. The update catalogs 930, in some embodiments, comprise information for each component of the fixes and/or other mitigation actions related to such vulnerabilities (e.g., identifying which version of an infrastructure component (e.g., a driver) fixes an identified security vulnerability). Thus, given an infrastructure component, it is possible to extract one or more potential vulnerabilities from the vulnerability catalogs 920, as well as the updates from the update catalogs 930 that will fix or mitigate such vulnerabilities

FIG. 10A through 10C illustrate exemplary processes 1000, 1040, 1080 associated with the various services 912, 914, 916, respectively, of the host computing device of FIG. 9 in accordance with an illustrative embodiment. In the example of FIG. 10A, the indirect passthrough data synchronization service process 1000 comprises stages 1 through 3 of the process 800 of FIG. 8, and a stage 4.2 portion of stage 4 of the process 800 of FIG. 8. In stage 1, the passthrough channel data is created and generated. In stage 2, the information is exchanged to synchronize the passthrough data across the multiple layers of an infrastructure stack, where each instance of the indirect passthrough data synchronization service process 1000 interacts with its own peer. In stage 3, the enabled status of the passthrough channels is evaluated. Finally, in stage 4.2, the vulnerability awareness information is exchanged.

In the example of FIG. 10B, the vulnerability collection service process 1040 comprises a stage 4.1 portion of stage 4 of the process 800 of FIG. 8. In particular, in stage 4.1, vulnerabilities are collected at a corresponding layer of the infrastructure stack, for various vendors having component(s) in the corresponding layer, using respective vulnerability catalogs 920 and then the collected vulnerability information is passed across stack layers using stage 4.2 of the indirect passthrough data synchronization service process 1000 of FIG. 10A.

In some embodiments, the vulnerability collection service process 1040 can refresh vulnerabilities in the respective vulnerability catalogs 920 periodically, for example, locking in step with CVE (Common Vulnerabilities and Exposures) Updates and Vulnerability Catalogs comprising known security flaws.

In the example of FIG. 10C, the vulnerability mitigation service process 1080 comprises stages 5 and 6 of the process 800 of FIG. 8. The vulnerability mitigation service process 1080 prioritizes the available vulnerability remediation in stage 5. In stage 6, the vulnerability remediation is initiated. In various embodiments, the vulnerability mitigation service process 1080 can be initiated through automation, DevOps, API interactions, workflows or by a user.

FIG. 11 is a sample table of an exemplary passthrough channel data structure 1100 that records vulnerability information that is exchanged among the layers of an infrastructure stack, according to an embodiment of the disclosure. As indicated above, the exemplary passthrough channel data structure 1100 can be used to track vulnerabilities and locations where fixes and/or other mitigation actions should be applied (up and down an infrastructure stack). In the example of FIG. 11, the various passthrough channels impact one or more of a virtual machine, a hypervisor and the iDRAC. Thus, the virtual machine, hypervisor and iDRAC may all access the same information in the exemplary passthrough channel data structure 1100. In some implementations, the vulnerability information may also be maintained for one or more additional layers, such as a workload layer.

For the exemplary operating system-to-BMC passthrough channel in the first row of the exemplary passthrough channel data structure 1100, the BMC (iDRAC) may have a Redfish endpoint (e.g., a RESTful interface), such as “/redfish/v1/IndirectPassthroughDevices/”. Under this endpoint, the iDRAC will first populate the operating system-to-BMC passthrough channel, for example, indicating an iDRAC identifier, how the iDRAC refers to the BMC and a status of the channel.

In addition, the hypervisor may have a WMI (Windows Management Interface)/WSMAN (Web Services Management) resource, such as “CIM_IndirectPassthroughDevices”. Under this endpoint, the hypervisor will first populate the operating system-to-BMC passthrough channel, for example, indicating a hypervisor identifier, how the hypervisor refers to the operating system and a status of the channel.

The vulnerabilities and locations where fixes and/or other mitigation actions that should be applied in the infrastructure stack, as indicated in the final column of the passthrough channel data structure 1100, are obtained in the manner described above from one or more vulnerability catalogs and one or more update catalogs, respectively. The indicated vulnerabilities and locations may be evaluated, for example, weekly or with a cadence corresponding to the vulnerability catalog and/or update catalog release schedule.

For an exemplary passthrough channel between a virtual machine and a physical device (e.g., a disk) in the second row of the exemplary passthrough channel data structure 1100, the hypervisor will have knowledge of the channel and can create an additional entry in the “CIM_IndirectPassthroughDevices” endpoint for storage in the exemplary passthrough channel data structure 1100. The following exemplary information can be added to passthrough channel data structure 1100 associated with the virtual machine-to-disk passthrough channel:

a Serial Number, MAC Address or another universal indicator (e.g., serial number and part number) for the disk (allowing the disk identifier to be used for reconciliation across multiple levels of the infrastructure stack; if the disk is a partition, the serial number of the physical disk can be collected);

a source identifier (e.g., hypervisor hostname) and an identifier of the disk as known to the hypervisor;

a target identifier (e.g., a virtual machine identifier and/or a virtual machine hostname); and

an identifier of the drive in the virtual machine as understood by the hypervisor (e.g., using the metadata stored by the hypervisor about the virtual machine).

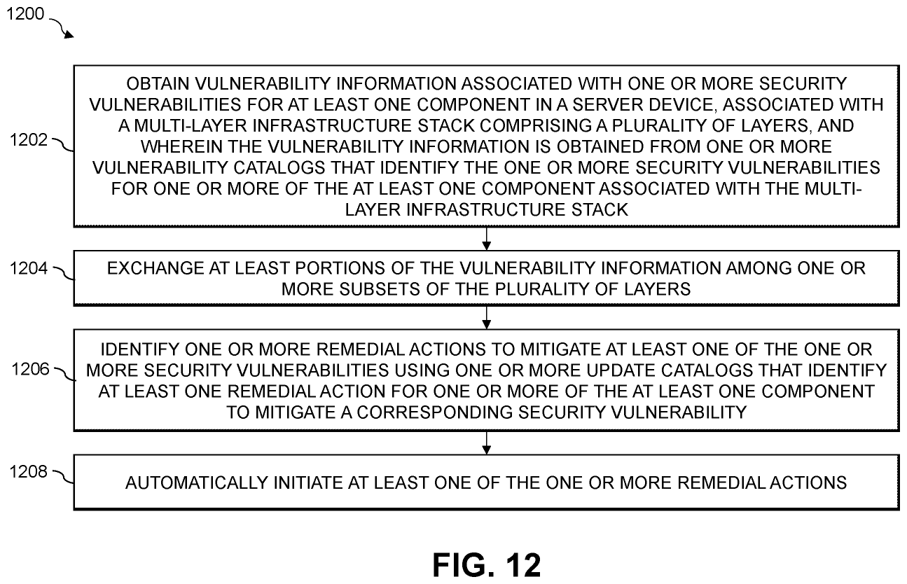

FIG. 12 is a flow chart illustrating an exemplary implementation of a security vulnerability mitigation process 1200 that identifies and mitigates one or more security vulnerabilities in a multi-layer infrastructure stack in accordance with an illustrative embodiment. In the example of FIG. 12, the security vulnerability mitigation process 1200 initially obtains vulnerability information in step 1202 associated with one or more security vulnerabilities for at least one component in a server device, wherein the is server device associated with a multi-layer infrastructure stack comprising a plurality of layers, and wherein the vulnerability information is obtained from one or more vulnerability catalogs that identify the one or more security vulnerabilities for one or more of the at least one component associated with the multi-layer infrastructure stack. In step 1204, at least portions the vulnerability information is exchanged among one or more subsets of the plurality of layers.

The security vulnerability mitigation process 1200 identifies one or more remedial actions in step 1206 to mitigate at least one of the one or more security vulnerabilities using one or more update catalogs that identify at least one remedial action for one or more of the at least one component to mitigate a corresponding security vulnerability. Finally, at least one of the one or more remedial actions are automatically initiated in step 1208.

In some embodiments, the one or more security vulnerabilities are associated with one or more of (i) a passthrough channel between two of the at least one component that reside in non-adjacent layers of the multi-layer infrastructure stack; and (ii) an interface that exposes a network connection that does not satisfy one or more security policies.

The vulnerability information for a given security vulnerability may identify, for a given layer of the multi-layer infrastructure stack, one or more of: the one or more of the at least one component associated with the given security vulnerability and an object representation exchanged between boundaries to a next layer of the multi-layer infrastructure stack. For example, a given layer of the multi-layer infrastructure stack may resolve the one or more of the at least one component associated with the given security vulnerability in the exchanged vulnerability information using one or more universal identifiers of the one or more of the at least one component.

The particular processing operations and other functionality described in conjunction with FIGS. 8, 9, 10A through 10C, and 12 are presented by way of illustrative example only, and should not be construed as limiting the scope of the disclosure in any way. Alternative embodiments can use other types of processing operations for security vulnerability mitigation. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

For additional details related to management, configuration, update, security, deployment and/or processing of infrastructure stacks, see, for example, U.S. patent application Ser. No. ______, entitled “Server Device Updates Using Update Baselines Tagged Across Multiple Management Consoles,” (Attorney Docket No. 128033); U.S. patent application Ser. No. ______, entitled “Generating Multi-Layer Configuration Templates for Deployment Across Multiple Infrastructure Stack Layers,” (Attorney Docket No. 128035); and/or U.S. patent application Ser. No. ______, entitled “Semantic-Aware Workflow Creation and Execution,” (Attorney Docket No. 128036), each filed contemporaneously herewith and incorporated by reference herein in its entirety.

One or more embodiments of the disclosure provide improved methods, apparatus and computer program products for identifying and mitigating security vulnerabilities in multi-layer infrastructure stacks. The foregoing applications and associated embodiments should be considered as illustrative only, and numerous other embodiments can be configured using the techniques disclosed herein, in a wide variety of different applications.

It should also be understood that the disclosed security vulnerability mitigation techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for security vulnerability mitigation may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based security vulnerability mitigation engine, or portions thereof, are illustratively implemented for use by tenants of such a multi-tenant environment.

Virtual machines provided in cloud-based systems can be used to implement at least portions of a cloud-based security vulnerability mitigation platform in illustrative embodiments. The cloud-based systems can include, for example, object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

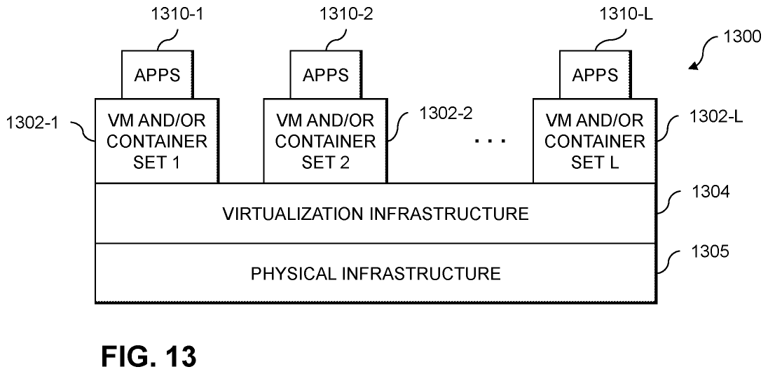

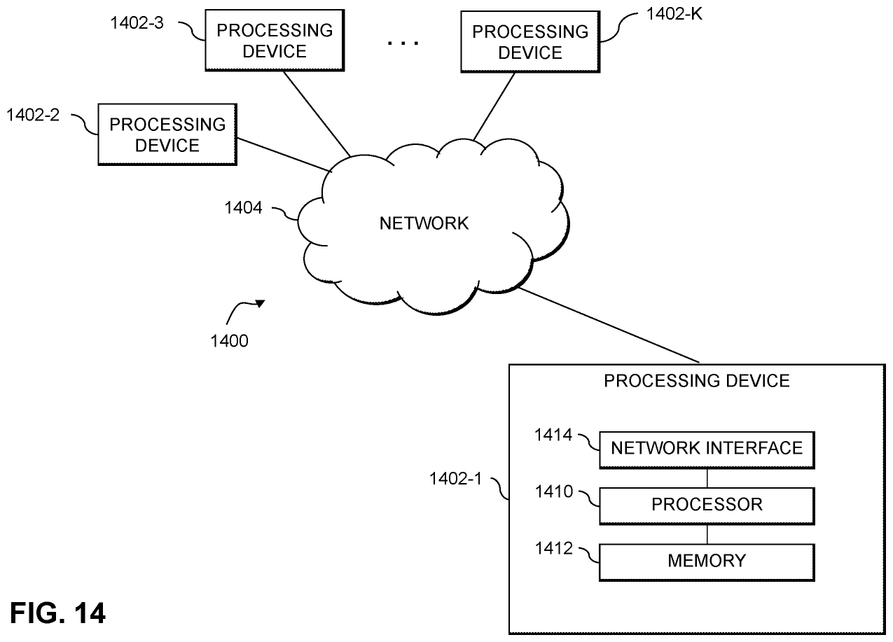

Illustrative embodiments of processing platforms will now be described in greater detail with reference to FIGS. 13 and 14. These platforms may also be used to implement at least portions of other information processing systems in other embodiments.

FIG. 13 shows an example processing platform comprising cloud infrastructure 1300. The cloud infrastructure 1300 comprises a combination of physical and virtual processing resources that may be utilized to implement at least a portion of the information processing system 100. The cloud infrastructure 1300 comprises multiple virtual machines (VMs) and/or container sets 1302-1, 1302-2, . . . 1302-L implemented using virtualization infrastructure 1304. The virtualization infrastructure 1304 runs on physical infrastructure 1305, and illustratively comprises one or more hypervisors and/or operating system level virtualization infrastructure. The operating system level virtualization infrastructure illustratively comprises kernel control groups of a Linux operating system or other type of operating system.

The cloud infrastructure 1300 further comprises sets of applications 1310-1, 1310-2, . . . 1310-L running on respective ones of the VMs/container sets 1302-1, 1302-2, . . . 1302-L under the control of the virtualization infrastructure 1304. The VMs/container sets 1302 may comprise respective VMs, respective sets of one or more containers, or respective sets of one or more containers running in VMs.

In some implementations of the FIG. 13 embodiment, the VMs/container sets 1302 comprise respective VMs implemented using virtualization infrastructure 1304 that comprises at least one hypervisor. Such implementations can provide security vulnerability mitigation functionality of the type described above for one or more processes running on a given one of the VMs. For example, each of the VMs can implement security vulnerability mitigation control logic and vulnerability identification functionality for one or more processes running on that particular VM.

An example of a hypervisor platform that may be used to implement a hypervisor within the virtualization infrastructure 1304 is the VMware® vSphere® which may have an associated virtual infrastructure management system such as the VMware® vCenter™. The underlying physical machines may comprise one or more distributed processing platforms that include one or more storage systems.

In other implementations of the FIG. 13 embodiment, the VMs/container sets 1302 comprise respective containers implemented using virtualization infrastructure 1304 that provides operating system level virtualization functionality, such as support for Docker containers running on bare metal hosts, or Docker containers running on VMs. The containers are illustratively implemented using respective kernel control groups of the operating system. Such implementations can provide security vulnerability mitigation functionality of the type described above for one or more processes running on different ones of the containers. For example, a container host device supporting multiple containers of one or more container sets can implement one or more instances of security vulnerability mitigation control logic and vulnerability identification functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1300 shown in FIG. 13 may represent at least a portion of one processing platform. Another example of such a processing platform is processing platform 1400 shown in FIG. 14.

The processing platform 1400 in this embodiment comprises at least a portion of the given system and includes a plurality of processing devices, denoted 1402-1, 1402-2, 1402-3, . . . 1402-K, which communicate with one another over a network 1404. The network 1404 may comprise any type of network, such as a WAN, a LAN, a satellite network, a telephone or cable network, a cellular network, a wireless network such as WiFi or WiMAX, or various portions or combinations of these and other types of networks.

The processing device 1402-1 in the processing platform 1400 comprises a processor 1410 coupled to a memory 1412. The processor 1410 may comprise a microprocessor, a CPU, a GPU, a TPU, a microcontroller, an ASIC, an FPGA or other type of processing circuitry, as well as portions or combinations of such circuitry elements, and the memory 1412, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1402-1 is network interface circuitry 1414, which is used to interface the processing device with the network 1404 and other system components, and may comprise conventional transceivers.

The other processing devices 1402 of the processing platform 1400 are assumed to be configured in a manner similar to that shown for processing device 1402-1 in the figure.

Again, the particular processing platform 1400 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 13 or 14, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining vulnerability information associated with one or more security vulnerabilities for at least one component in a server device, wherein the server device is associated with a multi-layer infrastructure stack comprising a plurality of layers, and wherein the vulnerability information is obtained from one or more vulnerability catalogs that identify the one or more security vulnerabilities for one or more of the at least one component associated with the multi-layer infrastructure stack;
exchanging at least portions of the vulnerability information among one or more subsets of the plurality of layers;
identifying one or more remedial actions to mitigate at least one of the one or more security vulnerabilities using one or more update catalogs that identify at least one remedial action for one or more of the at least one component to mitigate a corresponding security vulnerability; and
automatically initiating at least one of the one or more remedial actions;
wherein the method is performed by at least one processing device comprising a processor coupled to a memory.

2. The method of claim 1, wherein the one or more security vulnerabilities are associated with one or more of (i) a passthrough channel between two of the at least one component that reside in non-adjacent layers of the multi-layer infrastructure stack; and (ii) an interface that exposes a network connection that does not satisfy one or more security policies.

3. The method of claim 1, wherein the vulnerability information for a given security vulnerability identifies, for a given layer of the multi-layer infrastructure stack, one or more of: the one or more of the at least one component associated with the given security vulnerability and an object representation exchanged between boundaries to a next layer of the multi-layer infrastructure stack.

4. The method of claim 3, wherein a given layer of the multi-layer infrastructure stack resolves the one or more of the at least one component associated with the given security vulnerability in the exchanged vulnerability information using one or more universal identifiers of the one or more of the at least one component.

5. The method of claim 1, further comprising determining whether one or more of a communication channel and one or more of the at least one component associated with a given security vulnerability is enabled to determine if the given security vulnerability is exposed.

6. The method of claim 1, wherein the vulnerability information is separately obtained for each layer of the multi-layer infrastructure stack.

7. The method of claim 6, wherein a given layer of the multi-layer infrastructure stack employs one or more corresponding vulnerability catalogs that identify the one or more security vulnerabilities for one or more of the at least one component associated with the given layer.

8. The method of claim 1, wherein the one or more update catalogs identify one or more versions of a given at least one component that address one or more of the security vulnerabilities associated with the given at least one component.

9. The method of claim 1, further comprising prioritizing the one or more remedial actions based at least in part on an assessment of a business impact of at least one security vulnerability associated with each remedial action.

10. An apparatus comprising:
at least one processing device comprising a processor coupled to a memory;
the at least one processing device being configured to implement the following steps:
obtaining vulnerability information associated with one or more security vulnerabilities for at least one component in a server device, wherein the server device is associated with a multi-layer infrastructure stack comprising a plurality of layers, and wherein the vulnerability information is obtained from one or more vulnerability catalogs that identify the one or more security vulnerabilities for one or more of the at least one component associated with the multi-layer infrastructure stack;
exchanging at least portions of the vulnerability information among one or more subsets of the plurality of layers;
identifying one or more remedial actions to mitigate at least one of the one or more security vulnerabilities using one or more update catalogs that identify at least one remedial action for one or more of the at least one component to mitigate a corresponding security vulnerability; and
automatically initiating at least one of the one or more remedial actions.

11. The apparatus of claim 10, wherein the one or more security vulnerabilities are associated with one or more of (i) a passthrough channel between two of the at least one component that reside in non-adjacent layers of the multi-layer infrastructure stack; and (ii) an interface that exposes a network connection that does not satisfy one or more security policies.

12. The apparatus of claim 10, wherein the vulnerability information for a given security vulnerability identifies, for a given layer of the multi-layer infrastructure stack, one or more of: the one or more of the at least one component associated with the given security vulnerability and an object representation exchanged between boundaries to a next layer of the multi-layer infrastructure stack.

13. The apparatus of claim 10, further comprising determining whether one or more of a communication channel and one or more of the at least one component associated with a given security vulnerability is enabled to determine if the given security vulnerability is exposed.

14. The apparatus of claim 10, wherein the vulnerability information is separately obtained for each layer of the multi-layer infrastructure stack, and wherein a given layer of the multi-layer infrastructure stack employs one or more corresponding vulnerability catalogs that identify the one or more security vulnerabilities for one or more of the at least one component associated with the given layer.

15. The apparatus of claim 10, wherein the one or more update catalogs identify one or more versions of a given at least one component that address one or more of the security vulnerabilities associated with the given at least one component.

16. A non-transitory processor-readable storage medium having stored therein program code of one or more software programs, wherein the program code when executed by at least one processing device causes the at least one processing device to perform the following steps:
obtaining vulnerability information associated with one or more security vulnerabilities for at least one component in a server device, wherein the server device is associated with a multi-layer infrastructure stack comprising a plurality of layers, and wherein the vulnerability information is obtained from one or more vulnerability catalogs that identify the one or more security vulnerabilities for one or more of the at least one component associated with the multi-layer infrastructure stack;
exchanging at least portions of the vulnerability information among one or more subsets of the plurality of layers;
identifying one or more remedial actions to mitigate at least one of the one or more security vulnerabilities using one or more update catalogs that identify at least one remedial action for one or more of the at least one component to mitigate a corresponding security vulnerability; and
automatically initiating at least one of the one or more remedial actions.

17. The non-transitory processor-readable storage medium of claim 16, wherein the one or more security vulnerabilities are associated with one or more of (i) a passthrough channel between two of the at least one component that reside in non-adjacent layers of the multi-layer infrastructure stack; and (ii) an interface that exposes a network connection that does not satisfy one or more security policies.

18. The non-transitory processor-readable storage medium of claim 16, wherein the vulnerability information for a given security vulnerability identifies, for a given layer of the multi-layer infrastructure stack, one or more of: the one or more of the at least one component associated with the given security vulnerability and an object representation exchanged between boundaries to a next layer of the multi-layer infrastructure stack.

19. The non-transitory processor-readable storage medium of claim 16, wherein the vulnerability information is separately obtained for each layer of the multi-layer infrastructure stack, and wherein a given layer of the multi-layer infrastructure stack employs one or more corresponding vulnerability catalogs that identify the one or more security vulnerabilities for one or more of the at least one component associated with the given layer.

20. The non-transitory processor-readable storage medium of claim 16, wherein the one or more update catalogs identify one or more versions of a given at least one component that address one or more of the security vulnerabilities associated with the given at least one component.
